(19) United States
(12) Patent Application Publication
(10) Pub. No.: US 2011/0187543 A1
(43) Pub. Date: Aug. 4, 2011

(54) HOME SAFETY 911 SYSTEM

(76) Inventors: Linda Russo, Freehold, NJ (US); Vincenzo Tedesco, Freehold, NJ (US)

(21) Appl. No.: 13/020,808

(22) Filed: Feb. 4, 2011

Related U.S. Application Data
(60) Provisional application No. 61/301,533, filed on Feb. 4, 2010.

(51) Int. Cl. G08B 17/10

(52) U.S. Cl. 340/628

(57) ABSTRACT

A home safety 911 system which comprises a battery disposed in an enclosure that supplies power to a smoke sensor, a carbon monoxide sensor and a gas leak sensor. An audible alarm module, a visual alarm module and an escape route module are all disposed in the enclosure and can be activated by any one of the sensors. A “FIRE 911” visual alarm display is mounted on at least one window in a house and is remotely activated by the visual alarm module.

### CROSS-REFERENCE TO RELATED APPLICATION

This application claims the benefit of Provisional Patent Application No. 61/301,533, filed on Feb. 4, 2010, in the United States Patent & Trademark Office, the disclosure of which is incorporated herein by reference.

### BACKGROUND OF THE INVENTION

1. Field of the Invention

The present invention relates to an emergency detection device, and more particularly, a home safety 911 system.

The present invention allows smoke, carbon monoxide, and gas leaks to be detected to save lives. The system alerts users of a fire, gas leak, or the presence of carbon monoxide using audible warnings and flashing red, white, and blue lights. There are also adjustable directional lights that highlight an escape route. In addition, the system includes window decals that are illuminated when the system is activated. This will signal rescue teams the exact location of the emergency. The colored lights and audible alarm can also assist in warning occupants, neighbors, and people passing by that a fire or other urgent situation is occurring, allowing individuals to seek safety from their home.

2. Description of the Prior Art

Traditional smoke alarms emit a beeping noise when smoke is detected. Individuals have a tendency to sleep through the beeping because it is not always startling enough to arouse someone from a deep sleep. It may also not be loud enough to be heard from the outside of a house to alert neighbors of an emergency. If an individual is not provided with ample warning of a hazardous situation, there may be injuries or fatalities. A more efficient way is needed.

Numerous innovations for visual signaling apparatuses have been provided in the prior art that will be described. Even though these innovations may be suitable for the specific individual purposes to which they address, however, they differ from the present invention.

A FIRST EXAMPLE, U.S. Pat. No. 4,257,039, issued on Mar. 17, 1981, to Webb, et al. teach a smoke detector that is battery operated and may employ an ionization chamber and/or an infrared detector. When the alarm circuit is actuated due to the presence of smoke levels above a predetermined value being sensed by the detector, the alarm is actuated and each of the built in lights is illuminated. An auxiliary light energizeable by the detector is adapted to disengage one of the lights electrically and to be energized at the same time the other of the lights is energized.

A SECOND EXAMPLE, U.S. Pat. No. 4,283,657, issued on Aug. 11, 1981, to Gordon et al. teach an exit illuminating system for illuminating an exit or exit sign with high intensity light under emergency conditions, the light having sufficient brilliance to be visible through smoke in order to lead persons who may be trapped in the smoke-filled area to the escape exit. The system incorporates an emergency condition detector responsive to power failure, smoke and heat in order to develop an activating signal which energizes a high intensity xenon flash lamp. The system is made fail-safe by a circuit which causes a battery to power the flash lamp if line power is lost and which keeps the battery at full charge when external power is available.

A THIRD EXAMPLE, U.S. Pat. No. 4,365,238, issued on Dec. 21, 1982, to Kollin teaches an apparatus for visually signaling hearing impaired persons of the occurrence of an audible sound producing event. A plurality of sensing devices are individually located adjacent to a sound producing device, such as a telephone, doorbell, fire detector, etc., to sense the audible sounds produced by the activation of such devices. The output signals from the sensing devices are arranged in a predetermined priority ranking to enable a more important event to take precedence over an already occurring less important event. A sensing device transmits a signal to a central logic unit indicating the activation of one of the sound producing devices. The central logic unit identifies which sensing device sent the signal and transmits a predetermined sequence of output pulses associated with the particular activated device to a plurality of control modules. The control modules are each associated with an illuminating device, such as a light, and turn the associated light on and off in a predetermined sequence according to the received output pulses from the central logic unit to signal the hearing impaired person which sound producing event has taken place.

A FOURTH EXAMPLE, U.S. Pat. No. 4,812,821, Issued on Mar. 14, 1989, to Santy, et al. teaches a fire alert system providing a visual signal, such as a flashing light, in the event of actuation of one or more heat or smoke-sensing detectors. Each detector is wired to an alarm panel, as is a small signal transmitter having prongs for connection to a wall receptacle in an existing wiring circuit. When a detector is actuated, indicating the presence or possibility of a fire, relay contacts are closed in both the alarm panel and the transmitter to cause a signal to be transmitted through the wiring circuit from the transmitter to one or more receivers, also plugged into receptacles of the wiring circuit for actuation by the signal from the transmitter. A high intensity light associated with each receiver flashes in response to the actuating signal, thereby providing the visible fire alert signal.

A FIFTH EXAMPLE, U.S. Pat. No. 5,019,805, issued on May 28, 1991, to Curl et al. teach a smoke detector designed to warn hearing impaired persons of fire or smoke. A small, attractive, and inexpensive wall or ceiling mounted unit houses a dual chamber ionization detector, piezoelectric alarm horn, and a high intensity xenon strobe unit producing approximately 130 candela. In one embodiment, it is powered only from standard 120 volt AC power, although an internal battery standby version and low voltage D.C. version are alternative embodiments. The unit is furnished with a surface mount housing. It can easily be moved from room to room as required and it is intended to be easily hung on the wall about a foot from the ceiling.

A SIXTH EXAMPLE, U.S. Pat. No. 5,177,461, issued on Jan. 5, 1993, to Budzyna et al. teach a flashing alarm device responsive to audible signals produced by a smoke detector when the smoke detector senses a smoke condition, the alarm device including a circuit with a microphone portion for responding to audible signals produced by the smoke detector and an amplifier circuit portion for amplifying signals produced by the microphone, a switch circuit portion having a control input connected to the output of the amplifier circuit portion, and another circuit portion including a battery, a timer circuit, and a light bulb, the battery having a connection to the amplifier circuit and to the timer circuit, the timer circuit and the light bulb being connected in series with the switch circuit portion for energizing and de-engergizing the light bulb whenever the switch circuit portion is in its conducting condition. The device may also include a housing for the components and the device may optionally be constructed to operate on transmitted and received radio frequency signals.

A SEVENTH EXAMPLE, U.S. Pat. No. 5,731,759, issued on Mar. 24, 1998, to Finucan teaches a combined flashlight, smoke detector and emergency alarm assembly. A housing contains a flashlight having a bulb, reflector and window at one housing surface for illuminating an area adjacent to the assembly. A smoke detector is enclosed by the housing and includes an alarm for indicating the presence of smoke. A relay automatically turns the flashlight on when the alarm is activated. Vents in the housing permit ingress of smoke to the detector. A battery assembly in the housing provides power for the flashlight, smoke detector and alarm. A manually operable, momentary, normally closed, switch is provided to permit the alarm to be disabled, with the alarm enabled if this switch is released. Another switch is provided to enable the alarm independent of the smoke detector system as an emergency alarm. A manual flashlight switch is further provided to permit the flashlight to be used in a normal manner in a non-alarm situation. The battery assembly includes plural battery cells providing a higher voltage to the smoke alarm and having a tap to provide a relatively lower voltage to the flashlight.

AN EIGHTH EXAMPLE, U.S. Pat. No. 5,969,437, Issued on Oct. 19, 1999, to Foerster teach a dual powered flashlight responsive to an audible smoke detector alarm includes a sound sensor for sensing an audible smoke detector alarm and producing an electrical alarm signal in response; a frequency-sensitive amplifier amplifying the electrical alarm signal but not other signals; an integrator for integrating the electrical alarm signal amplified by the frequency-sensitive amplifier and for generating a trigger signal only when the integrated signal exceeds a threshold; a lamp; a battery connector for receiving a battery for providing current for illuminating the lamp; a power supply including a mains connector connectable to electrical power lines and powering the frequency-sensitive amplifier and the integrator; and a switch receiving the trigger signal and a power supply signal from the power supply for connecting the lamp to the battery in response to at least one of a trigger signal and absence of application of electrical power to the mains connector. The flashlight illuminates automatically in the event of a power failure or generation of a smoke detector alarm and remains illuminated so long as the power failure or alarm continues or upon unplugging from the power lines to aid in escape from smoke or a power failure.

A NINTH EXAMPLE, U.S. Pat. No. 6,249,221, issued on Jun. 19, 2001, to Reed teaches an escape system for aiding a person in finding an exit door in the event of an emergency situation of limited visibility. The escape system can includes at least one heat detector and at least one smoke detector, an audible alarm circuitry, a dynamic pulsating door base light, and an optional continuous door base light. Upon detection of a threshold amount of heat or smoke by detectors, an audible detection signal is received by a remotely located microphone, and an alarm signal is generated for transmission by radio frequency (RF) by a RF transmitter. The alarm signal is received by a RF receiver located in an exit door alert unit, having associated circuitry for activating dynamic pulsating LED lights within the door alert unit. The illuminating and flashing LED lights attract the attention of a person in distress who may be crawling along the floor in a smoke-filled room, therefore assisting people to locate and exit a smoke filled and burning enclosure.

A TENTH EXAMPLE, U.S. Patent Office Publication No. 2004/0012951, published on Jan. 22, 2004, to Pylkki et al. teach a window unit that includes a window frame defining a frame perimeter and a glazing unit located within the frame perimeter. A window illumination element is on the glazing unit and produces an illuminated visual indicator in response to an activating signal. The activating signal may come from a smoke alarm or other alarm system. The window unit may also include additional illumination elements on the window frame or above the window and a speaker that responds to the activating signal.

AN ELEVENTH EXAMPLE, U.S. Pat. No. 6,690,288, issued on Feb. 10, 2004, to Waddell teaches an emergency response system including a smoke detector and an evacuation guide. The emergency response system and evacuation guide are separate components removably attached to each other, and each has a shape that includes a long, narrow neck and a curved handle, which permits both the smoke detector and evacuation guide to be installed by hanging each from a door knob. The smoke detector includes, in addition to means for sensing smoke and means for emitting an alarm, a radio transmitter that generates and transmits an activation signal in the form of radio waves. The radio waves are detected by a radio receiver in the evacuation guide. Upon receipt of the activation signal, a digital recording and playback device delivers a message to occupants of the home or building. A flashlight contained within the evacuation guide also is illuminated.

A TWELFTH EXAMPLE, U.S. Patent Office Publication No. 2005/0073405, published on Apr. 7, 2005, to Spoltore et al. teach a safety light that is activated by a wireless signal from a control panel in a home security system is responsive to detection of a fire by the system. The safety light alerts rescuers of rooms in a home in which children may be located. The light may be window, door or wall-mounted, and have a single, or dual opposing, backlit faces. The backlit face includes a logo and/or text that is quickly recognized by rescuers. For example, a logo of a firefighter carrying a baby may be used with the text “tot rescue”. The safety light may communicate status information to the control panel, such as a low battery condition or a tamper alert. A tamper alert switch detects tampering with the housing of the safety light or its installation. Additional safety lights provide ambient illumination and directional information to an exit.

A THIRTEENTH EXAMPLE, U.S. Patent Office Publication No. 2006/0038691, published on Feb. 23, 2006, to Bard teaches an emergency notification device in which a first warning unit detects the audible warning alarm emanating from an activated smoke detector, the first unit then sends a radio frequency signal to a second, window mounted, warning unit that provides a flashing light and sound notification to emergency personnel outside of a dwelling to indicate that persons or pets in need of rescue are located within the room in which the warning unit is located.

A FOURTEENTH EXAMPLE, U.S. Patent Office Publication No. 2007/0132575, published on Jun. 14, 2007, to Ellul teaches an emergency notification and directional signaling apparatus includes an alarm remotely mountable from and responsive to an emergency event detector and alarm. The remote alarm activates one of a supplementary visual and audible alarm which may include one or more different colored lights, one of which is a pulsed strobe, and an audible sound which may include a recorded voice message. A temperature sensor in the remote alarm housing activates a second notification and signaling event when the ambient temperature surrounding the remote alarm reaches a preset threshold. The remote alarm may be mounted in a portable housing, on a faceplate of an existing wall electrical junction box, or in an electrical duplex body mounted in a junction box.

A FIFTHEENTH EXAMPLE, U.S. Patent Office Publication No. 2007/0285265, published on Dec. 13, 2007, to Lax teaches a smoke detector system having abase unit and multiple satellite units. The base unit detects various hazards, i.e., smoke or carbon monoxide, and broadcasts a radio frequency signal to activate warning devices on the various satellite units. The satellite units include a radio frequency receiver to receive the signal broadcasted by the base unit. The warning devices include a laser cannon, a speaker, a strobe light, and a wireless camera separately or in combination with other warning devices. Alternatively, each base unit may include one or more of the warning devices and a radio frequency receiver, and each satellite unit may include the detection devices and a radio frequency transmitter. In this way, each device in the system may activate warning devices in each other device in the system when a hazard is detected.

A SIXTHTEENTH EXAMPLE, U.S. Pat. No. 7,420,473, issued on Sep. 2, 2008, to Eicken et al. teach a pet collar for alerting others as to the location of a pet. The pet collar is provided for announcing the presence, audibly and visibly, of a pet such as in a burning structure or otherwise when the pet cannot be found. The pet collar is adapted to work in cooperation with either a conventional or an improved smoke detector. In one embodiment, a radio frequency (RF) transmitter is used in cooperation with a conventional smoke detector to communicate with a pet collar of the present invention. In either embodiment, when the smoke detector sounds an audible alarm either automatically or manually, the pet collar is activated to sound an alarm and to illuminate at least one light. The pet collar is also useful in cooperation with other detectors such as a carbon monoxide detector or a security alarm.

A SEVENTEENTH EXAMPLE, U.S. Patent Office Publication No. 2008/0291037, published on Nov. 27, 2008, to Lax teaches a smoke detection and escape indication system includes a master controller in communication a base unit and a satellite unit. The base unit and the satellite unit are each in wireless communication with one another and include a wireless receiver, a wireless transmitter, a sensor for detecting a hazard and an escape indication mechanism. The base unit and the satellite unit cooperate to indicate an escape route by coordinating respective escape indication mechanisms in the event that one of the units detect a hazard.

AN EIGHTEENTH EXAMPLE, U.S. Pat. No. 7,619,538, issued on Nov. 17, 2009, to Zarian teaches evacuation systems, more particularly, it pertains to single or networked guiding devices that utilizing pre-programming and/or virtual programming, sensing and detecting means, illumination and alarming means, symbols and text messages to direct traffic to safety. The networked guiding devices of the system are configured to systematically and progressively direct traffic from one device to the next, directing traffic to safety. The system is configured to be controlled locally or remotely, on-demand. The evacuation system is applicable to people's traffic, vehicular traffic and/or other transportation modes. The evacuation system may be used in emergency or non-emergency situations.

A NINETEENTH EXAMPLE, U.S. Patent Office Publication No. 2010/00102960, published on Apr. 29, 2010, to Simon et al. teaches an emergency lighting system for a building includes at least one LED-based light. An emergency detector is operable to detect an emergency. The emergency detector produces an emergency signal in response to the emergency. A controller is operable to control the at least one LED-based light in response to the emergency signal.

A TWENTYEETH EXAMPLE, U.S. Patent Office Publication 2010/0073172, published on Mar. 25, 2010, to Lax teaches a dual condition fire/smoke detector system includes a housing and a sensor comprising at least two of a photoelectric sensor, a heat sensor, an ionization sensor or a carbon monoxide sensor disposed within the housing. A wireless communication system associated with the sensor enables communication of the detector with a remote device via a wireless receiver and a wireless transmitter. A light source associated with the housing may be positioned to illuminate an exit in response to a hazard detected by any of the aforementioned sensors.

A TWENTYFIRST EXAMPLE, U.S. Patent Office Publication No. 2010/0320922, published on Dec. 23, 2010, to Palazzolo et al. teaches an illumination device including light-emitting diodes, an alternating current input, a full-wave rectifier coupled to the alternating current input and configured to produce a rectified voltage output and a power converter, the power converter having a switching element electrically coupled to the rectified voltage output of the full-wave rectifier. An improvement of the illumination device includes a feedback circuit configured to determine an average current across the light-emitting diodes and to invert a signal representing the average current to provide a switching signal to the switching element such that, for a range of operating points, increasing a current drawn into the power converter will decrease LED power and decreasing the current drawn into the power converter will increase LED power.

It is apparent now that numerous innovations for visual signaling apparatuses have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a home safety 911 system that avoids the disadvantages of the prior art.

ANOTHER OBJECT of the present invention is to provide a home safety 911 system that is simple and inexpensive to manufacture.

STILL ANOTHER OBJECT of the present invention is to provide a home safety 911 system that is simple to use.

BRIEFLY STATED, STILL YET ANOTHER OBJECT of the present invention is to provide a home safety 911 system which comprises a battery disposed in an enclosure that supplies power to a smoke sensor, a carbon monoxide sensor and a gas leak sensor. An audible alarm. module, a visual alarm. module and an escape route module are all disposed in the enclosure and can be activated by any one of the sensors. A “FIRE 911” visual alarm display is mounted on at least one window in a house and is remotely activated by the visual alarm module.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a block diagram of the present invention;

FIG. 2 is an enlarged perspective view of the enclosure of the present invention;

FIG. 3 is a block diagram showing the components of the audible alarm module;

FIG. 4 is a block diagram showing the components of the visual alarm module;

FIG. 5 is a block diagram showing the components of the escape route module; and

FIG. 6 is an elevational view of a portion of a house showing the “FIRE 911” visual alarm display mounted in a window.

### REFERENCE NUMERALS UTILIZED IN THE DRAWING

110 house safety 911 system

112 enclosure of system 110

114 ceiling of house 116

115 wall of house 116

116 house

118 smoke sensor of system 110

120 carbon monoxide sensor of system 110

122 gas leak sensor of system 110

123 battery of system 110

124 audible alarm module of system 110

126 visual alarm module of system 110

128 escape route module of system 110

130 “FIRE 911” visual alarm display of system 110

132 window of house 116

134 circular shaped housing for enclosure 112

136 plastic of housing 134

138 metal of housing 134

140 first detector circuit of audible alarm module 124

142 sound mechanism of audible alarm module 124

144 voice recordings in sound mechanism 142

146 speaker of audible alarm module 124

147 person

148 second detector circuit of visual alarm module 126

150 light emitting diode of visual alarm module 126

152 third detector circuit of escape route module 128

154 two adjustable directional lights of escape route module 128

156 decal of “FIRE 911” visual alarm display 130

158 emergency information on decal 156

### DETAILED DESCRIPTION OF THE PREFERRED EMBODIMENT

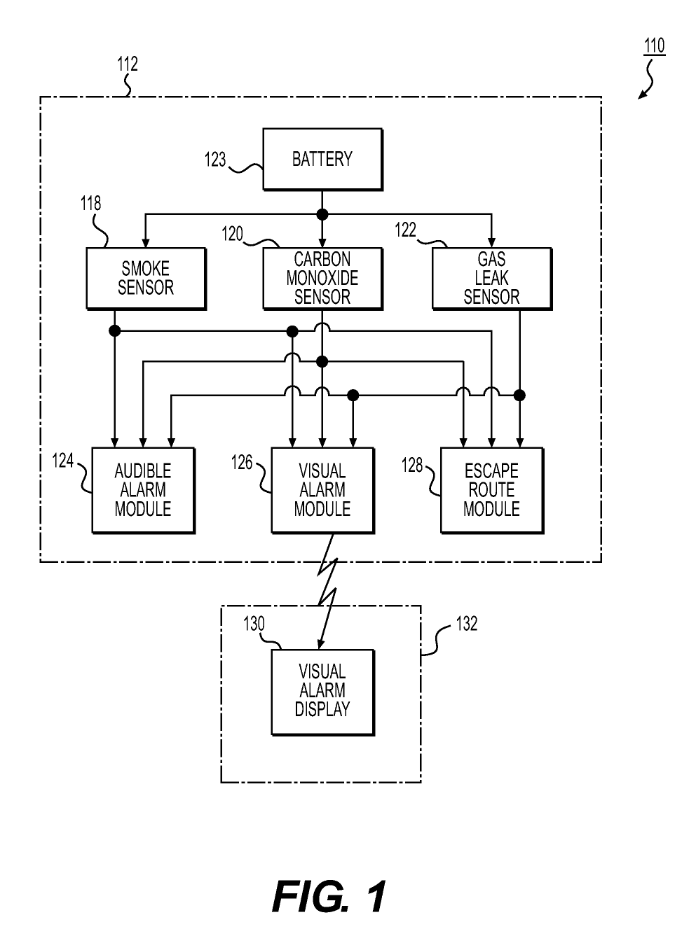

Referring now to the figures, in which like numerals indicate like parts, and particularly to FIGS. 1 through 6, and as such, will be discussed with reference thereto.

As shown in FIG. 1, a home safety 911 system 110 comprises an enclosure 112 mounted on a ceiling 114 or wall 115 in a house 116. A smoke sensor 118 is disposed in the enclosure 112 to detect an airborne smoke substance. A carbon monoxide sensor 120 is disposed in the enclosure 112 to detect an airborne carbon monoxide substance. A gas leak sensor 122 is disposed in the enclosure 112 to detect an airborne combustible gas substance. A battery 123 is disposed in the enclosure 112 to supply power to the smoke sensor 118, the carbon monoxide sensor 120 and the gas leak sensor 122.

An audible alarm module 124 is disposed in the enclosure 112 to be activated by any one of the sensors 118, 120, 122. A visual alarm module 126 is disposed in the enclosure 112 to be activated by any one of the sensors 118, 120, 122. An escape route module 128 is disposed in the enclosure 112 to be activated by any one of the sensors 118, 120, 122. A “FIRE 911” visual alarm display 130 is mounted on at least one window 132 in the house 116 that is remotely activated by the visual alarm module 126.

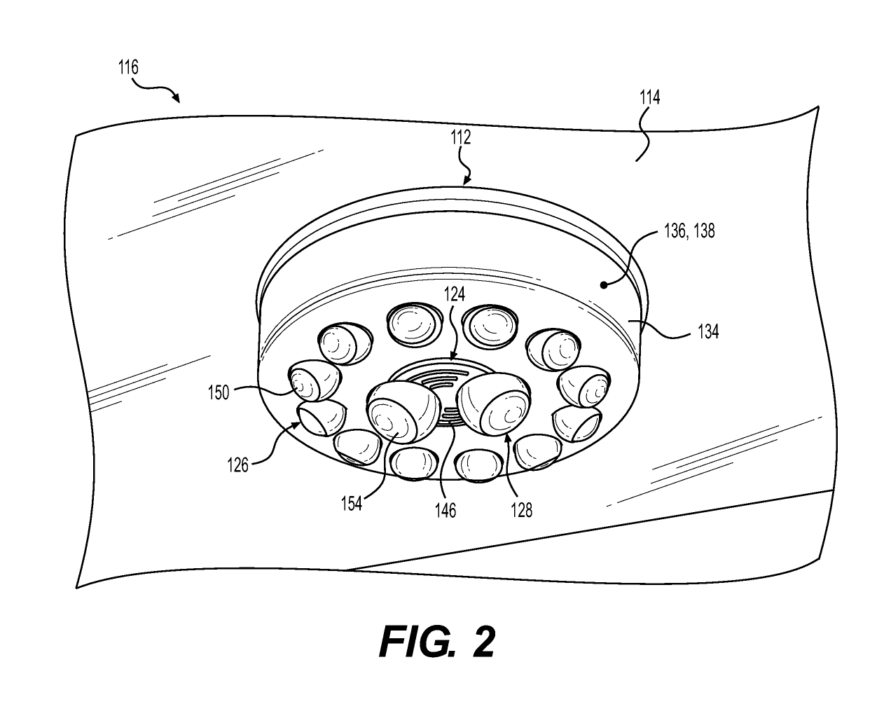

As shown in FIG. 2, the enclosure 112 comprises of a circular shaped housing 134 fabricated from a material selected from plastic 136 or metal 138.

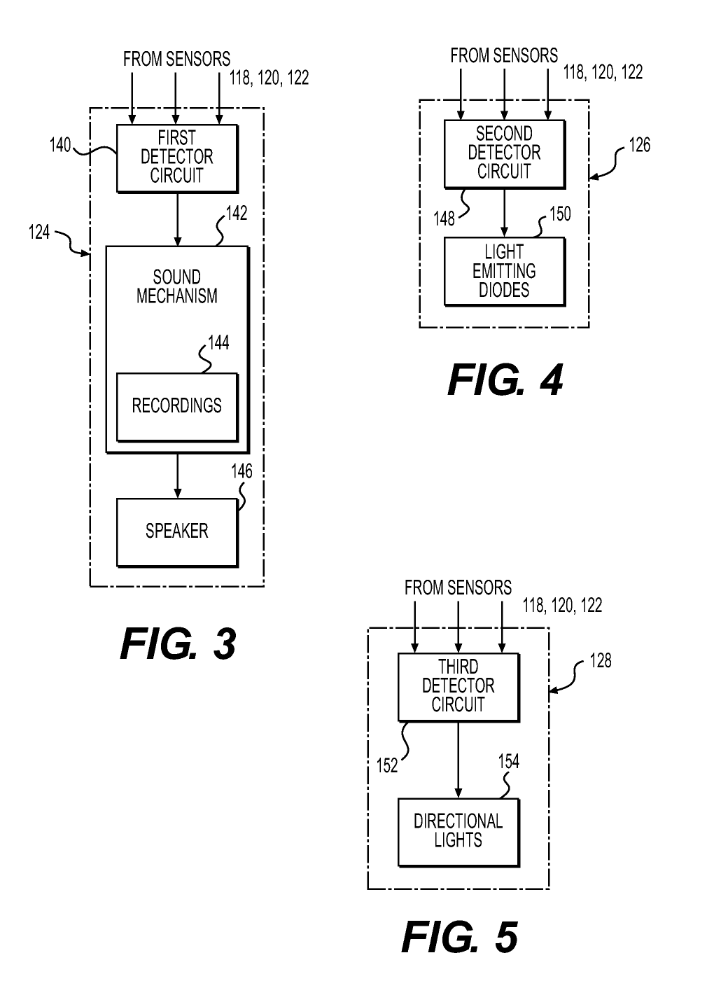

As shown in FIG. 3, the audible alarm module 124 consists of a first detector circuit 140 activated by any one of the sensors 118, 120, 122. A sound mechanism 142 is activated by the first detector circuit 140. The sound mechanism 142 has a plurality of voice recordings 144 therein. A speaker 146 is connected to the sound mechanism 142, in which one of the voice recordings 144 will be selected to verbally indicate through the speaker 146 that a specific airborne substance is present and instruct a person 147 to exit from the house 116.

As shown in FIG. 4, the visual alarm module 126 comprises a second detector circuit 148 activated by any one of the sensors 118, 120, 122. A plurality of twelve bright flashing light emitting diodes 150 are mounted about the enclosure 112 and are activated by the second detector circuit 148 to visually indicate that an airborne substance is present. The twelve bright flashing light emitting diodes 150, as shown in FIG. 2, are comprised in a variety of colors, such as red, white and blue in a circular pattern arrangement and positioned on the enclosure 112 at approximately a seventy-five degree angle. The light emitting diodes 150 will wake a sleeping person 147 and be visible from the exterior of the house 116 through the window 132. The twelve flashing light emitting diodes 150 include four white flashing light diodes, four red flashing light diodes and four blue flashing light diodes arranging in interleave mode white-red-blue.

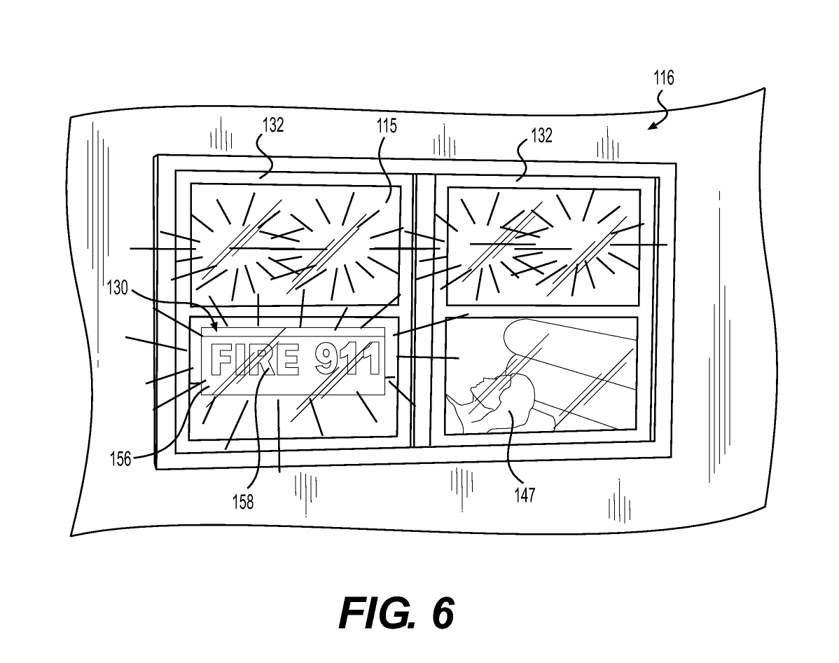

As shown in FIG. 5, the escape route module 128 comprises a third detector circuit 152 activated by any one of the sensors 118, 120, 122. Two adjustable directional lights 154, as shown in FIG. 2, are mounted in the center of the enclosure 112 and are activated by the third detector circuit 152 to visually indicate a proper escape route in the house 116 for the person 147. Each of the two adjustable directional lights 154, as shown in FIG. 2, is comprised out of a bright white color to enhance illumination for the escape route. The “FIRE 911” visual alarm display 130, as shown in FIG. 6, is comprised of a decal 156 having emergency information 158 placed thereon and is illuminated by the visual alarm module 126 to inform people outside of the house 116 that there is an emergency within the house 116.

When smoke, carbon monoxide or a gas leak is detected in the house 116, the system 110 will automatically activate the audible alarm module 124, the visual alarm module 126 and the escape route module 128. If smoke is detected the audible alarm module 124 will inform the person 147 within the house 116 “HELP FIRE IS DETECTED, GET OUT”. If carbon monoxide is detected the audible alarm module 124 will inform the person 147 within the house 116 “HELP CARBON MONOXIDE IS DETECTED, GET OUT”. If a gas leak is detected the audible alarm module 124 will inform the person 147 within the house 116 “HELP A GAS LEAK IS DETECTED, GET OUT”. The colored light emitting diodes 150 of the visual alarm module 126 will flash and the two adjustable directional lights 154 of the escape route module 128 will illuminate the escape route. The emergency information 158 on the decal 156 of the “FIRE 911” visual alarm display 130 on the window 132 of the house 116 will be illuminated by the visual alarm module 126.

It will be understood that each of the elements described above, or two or more together, may also find a useful application in other types of constructions differing from the types described above.

While the invention has been illustrated and described as embodiments of a home safety 911 system, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A home safety 911 system which comprises:
a) an enclosure mounted on a ceiling/wall in a house;
b) a smoke sensor disposed in the enclosure to detect an airborne smoke substance;
c) a carbon monoxide sensor disposed in the enclosure to detect an airborne carbon monoxide substance;
d) a gas leak sensor disposed in the enclosure to detect an airborne combustible gas substance;
e) a battery disposed in the enclosure to supply power to the smoke sensor, the carbon monoxide sensor and the gas leak sensor;
f) an audible alarm module disposed in the enclosure to be activated by any one of the sensors;
g) a visual alarm module disposed in the enclosure to be activated by any one of the sensors;
h) an escape route module disposed in the enclosure to be activated by any one of the sensors; and
i) a “FIRE 911” visual alarm display mounted remotely on at least one window in the house that is remotely activated by the visual alarm module.

2. The system as recited in claim 1, wherein the enclosure comprises a circular shaped housing fabricated from a material selected from the group consisting of plastic and metal.

3. The system as recited in claim 1, wherein the audible alarm module comprises:
a) a first detector circuit activated by any one of the sensors;
b) a sound mechanism activated by the first detector circuit, the sound mechanism having a plurality of voice recordings therein; and
c) a speaker connected to the sound mechanism, in which one of the voice recordings will be selected to verbally indicate through the speaker that a specific airborne substance is present and instruct a person to exit from the house such as “Help Carbon Monoxide Detected, Get Out”.

4. The system as recited in claim 1, wherein the visual alarm module comprises:
a) a second detector circuit activated by any one of the sensors; and
b) a plurality of twelve bright flashing light emitting diodes mounted about the enclosure and activated by the second detector circuit to visually indicate that an airborne substance is present.

5. The system as recited in claim 4, wherein the twelve bright flashing light emitting diodes are comprised in a variety of white, red and blue colors in an circular pattern arrangement and positioned on the enclosure at approximately a seventy-five degree angle, whereby the light emitting diodes will wake a sleeping person and be visible from the exterior of the house through the window.

6. The system as recited in claim 1, wherein the escape route module comprises:
a) a third detector circuit activated by any one of the sensors: and
b) two adjustable directional lights mounted in the center of the enclosure and activated by the third detector circuit to visually indicate a proper escape route in the house for the person.

7. The system as recited in claim 6, wherein each of the two adjustable directional lights is comprised out of a bright white color to enhance illumination for the escape route.

8. The system as recited in claim 1, wherein the “FIRE 911” visual alarm display is comprised of a decal having emergency information placed thereon and illuminated by the visual alarm module to inform people outside of the house that there is an emergency within the house.

9. The system as recited in claim 5, wherein the twelve flashing light emitting diodes 150 include four white flashing light diodes, four red flashing light diodes and four blue flashing light diodes arranging in interleave mode white-red-blue.
